(19) United States
(12) Patent Application Publication
(10) Pub. No.: US 2014/0330580 A1
(43) Pub. Date: Nov. 6, 2014

(54) SYSTEM AND METHOD FOR UNLOCKING AN OVER-THE-COUNTER BIOSIGNAL RECORDER

(71) Applicant: CARDIOCOMM SOLUTIONS, INC., North York (CA)

(72) Inventors: Etienne Grima, Scarborough (CA); Wade Barnes, Victoria (CA)

(73) Assignee: CardioComm Solutions, Inc., North York (CA)

(21) Appl. No.: 13/887,678

(22) Filed: May 6, 2013

(51) Int. Cl. G06F 19/00

(52) U.S. Cl. CPC G06F 19/322
USPC 705/3

(57) ABSTRACT

A system and method for allowing a patient/consumer access to recorded biosignals on an over-the-counter consumer biosignal recorder is disclosed. The method includes receiving at a monitoring server a registration request having an associated device identifier of the biosignal recorder and a user identifier of the patient/consumer. The patient/consumer is associated with the biosignal recorder in a registry of the monitoring server. A biosignal recording is received and a professional reviews the biosignal recording to generate a report that is transmitted to the patient/consumer. After the patient/consumer reviews the report, a confirmation is received at the monitoring server to confirm that the patient/consumer has reviewed the report, thus establishing the equivalent of a doctor-patient relationship. After this relationship has been established the monitoring server can update the device record of the biosignal recorder to indicate that it is eligible for unlocking.

### FIELD

The present disclosure relates generally to a system and method for allowing consumer or patient (“patient/consumer”) access to biosignals recorded on a biosignal recorder. More particularly, the disclosure relates to regulated, over-the-counter medical devices capable of recording biosignals.

### BACKGROUND

In the health care industry, medical devices are used for the diagnosis, prevention or treatment of diseases or other health conditions. Typically, a patient/consumer must be directed by a doctor to obtain access to a medical device(s) for diagnostic or treatments purposes. This can be a time consuming and costly process for the patient/consumer that can involve a visit to a doctor, referral to a specialist doctor, and finally attending a health care facility to be tested using the medical device.

Some medical devices capable of recording biosignals have limited functionality and may not be permitted to display a biosign reading so that they can be sold over-the-counter (OTC) directly to a consumer without a prescription from a healthcare professional. In most countries, use of biosign displaying devices as over-the-counter consumer medical devices are highly regulated. A patient/consumer typically is not able to view their recorded biosignal on an OTC medical device.

For example, small, portable, battery-powered medical devices can be used to allow a patient/consumer to record their electrocardiograph (ECG). Use of such devices are convenient for patient/consumer use as a heart rhythm symptom can occur at any time and at any location, such as at home, the office, or the gym, from which a common ECG device found in hospitals, clinics and labs is inaccessible in a timely manner. However, even if accessible, the patient/consumer is unable, due to regulatory controls, to obtain access to their recorded ECG on their own when a real rhythm symptom may present and must therefore wait to effect a visit with a physician, clinic or laboratory in order for them to access the ECG recording to provide a clinical diagnosis.

### SUMMARY

According to a first aspect, a method is provided for allowing a patient/consumer immediate access to recorded biosignals on an over-the-counter consumer biosignal recorder. The method comprises receiving at a server a registration request having an associated device identifier of the biosignal recorder and a user identifier of the patient/consumer; associating the user identifier with a device record stored in memory at the server, the device record identified by the device identifier; receiving at the server and storing in the memory a biosignal recording associated with the device identifier; transmitting a report from the server to the patient/consumer, the report prepared by a professional after review of the biosignal recording; receiving a confirmation from the patient/consumer at the server confirming that the patient/consumer has reviewed the report, the confirmation establishing a relationship between the professional and patient/consumer; and after receiving the confirmation, updating the device record identified by the device identifier of the biosignal recorder to indicate the biosignal recorder is eligible for unlocking to allow the patient/consumer access to further biosignal recordings from the biosignal recorder.

In some aspects the method further comprises after updating the device record to eligible for unlocking, transmitting an unlock instruction to the biosignal recorder. In some aspects, the unlock instruction can be performed in response receiving an unlock request from the patient/consumer. In some aspects, the unlock instruction can comprises a firmware update to allow access to recorded biosignals on the biosignal recorder. In some aspects the biosignal can be an electrocardiogram, or alternatively, any one of an electroencephalogram (EEG), magnetoencephalogram (MEG), galvanic skin response (GSR), electrocardiogram (ECG), electromyogram (EMG), and heart rate variability (HRV).

According to another aspect, a monitoring server is provided for allowing a patient/consumer immediate access to recorded biosignals on an over-the-counter consumer biosignal recorder. The system can comprise a memory for storing software instructions and a processor for executing the software instructions to configure the processor to receive at the monitoring server a registration request having an associated device identifier of the biosignal recorder and a user identifier of the patient/consumer; associate the user identifier with a device record stored in the memory, the device record identified by the device identifier; receive at the server and store in the memory a biosignal recording associated with the device identifier; transmit a report from the server to the patient/consumer, the report prepared by a professional after review of the biosignal recording; receive a confirmation from the patient/consumer at the server confirming that the patient/consumer has reviewed the report, the confirmation establishing a relationship between the professional and patient/consumer; and update the device record identified by the device identifier of the biosignal recorder after receiving the confirmation to indicate the biosignal recorder is eligible for unlocking to allow the patient/consumer access to further biosignal recordings from the biosignal recorder. In some aspects the processor can be further configured to transmit an unlock instruction to the biosignal recorder after updating the device record to eligible for unlocking.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a schematic diagram of a biosignal monitoring system;

FIG. 2 is a flow chart diagram of a method for allowing a patient/consumer immediate access to a recorded biosignals on an OTC consumer biosignal recorder; and

FIG. 3 is a block diagram of an exemplary computer architecture of a computing device, such as the monitoring server of FIG. 1.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

The term biosignal is used herein to include electrocardiogram (ECG), and can could also include, but is not limited to: electroencephalogram (EEG), magnetoencephalogram (MEG), galvanic skin response (GSR), electromyogram (EMG), and heart rate variability (HRV).

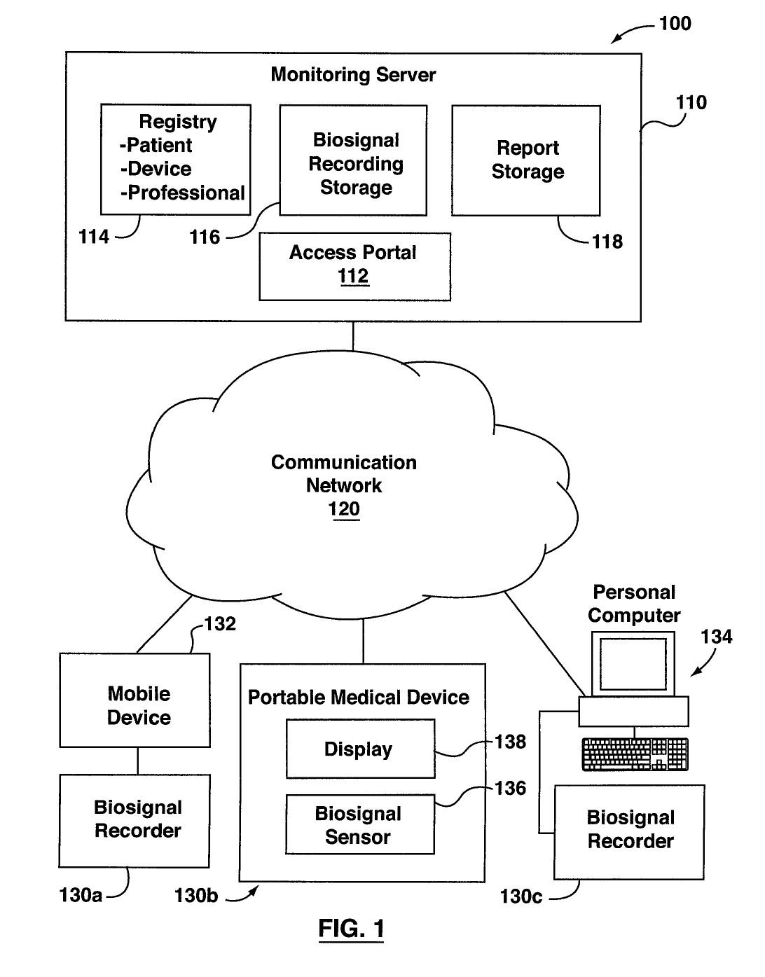

Reference is first made to FIG. 1, shown is a schematic diagram of a biosignal monitoring system comprising a monitoring server 110 coupled by a communication network 120 to any one of a number of biosignal recorders 130a-c. Monitoring server 110 receives biosignal recordings from patient/consumer that are using a biosignal recorder 130a-c to measure their biosignals. Monitoring server 110 can be used to control the operation and functionality of biosignal recorders 130a-c in accordance with regulatory governance of medical devices. More particularly, monitoring server 110 can enable certain functionality of biosignal recorders 130a-c after a doctor-patient relationship has been established through the use of the biosignal recorder 130a-c and review of corresponding recorded biosignals.

Biosignal recorders 130a-c are electronic devices that measure and record biosignals using a sensor that is coupled to the patient. Various types of sensors can be used for recording various biosignals as is known in the art. In a preferred embodiment, a biosignal recorder is used for measuring electrocardiography and can include one or more electrodes and a voltage sensor. Biosignal recorder 130a-c can further include a memory for storing biosignal recordings for later uploading to a coupled computing device or to monitoring server 110. Preferably, biosignal recorders 130a-c are portable and powered by a battery.

Biosignal recorders 130a-c can be coupled to a computing device, such as mobile device 132 or a personal computer 134. Mobile devices 132 and personal computers 134 are computing devices that have a processor, memory and a network interface to connect to monitoring server 110 through communication network 120. Mobile devices 132 can include, but are not limited to, smart phones, portable gaming devices and tablet computers. Personal computer 134 can include, but are not limited to, general-purpose computers (e.g. desktop and laptop computers), set-top boxes, and video game consoles. Wired and wireless interfaces can be used to couple biosignal recorders 130a-c to computing devices. For example, biosignal recorders 130a-c can be coupled to a computing device using wired interfaces, such as USB and audio interfaces, wireless personal area networks, such as Bluetooth™, and wired and wireless local area networks, such as those standardized by IEEE 802.3 and 802.11.

In other embodiments, biosignal recorder 130b can comprise computing device elements integrated as a portable medical device, and can include a biosignal sensor 136 and display 138, as well as a processor and memory. The integrated computing device of biosignal recorder 130b can use biosignal sensor 136 to record biosignals. Display 138 can provide a user interface for the patient/consumer to interact with software that communicates with monitoring server 110. If biosignal recorder 130b is unlocked, recorded biosignals can be viewed on display 138.

Communication network 120 allows transmission and receipt of data between biosignal recorders 130a-c and monitoring server 110. Communication network 120 can comprise private and public networks, such as the internet, and can include either wired, wireless or a combination of both.

Biosignal recorders 130a-c can be purchased by the patient/consumer over-the-counter (OTC), or under prescription, in a locked state with limited initial functionality. Regulatory governance limits access by the patient/consumer to the biosignals recorded by biosignal recorders 130a-c. The locked biosignal recorder can limit the display of recorded biosignals on an associated display, downloading the data from the biosignal recorder for processing by software, or producing reports based on the recorded biosignals. Biosignal recorders 130a-c can be eligible for unlocking after a patient-physician, or equivalent, relationship has been established. An unlock eligible biosignal recorder 130a-c can then be unlocked by a method of operating monitoring server 110 that can be embodied in software stored in memory of monitoring server 110. After undergoing the unlocking process, the true recorded biosignals can be displayed on the device, accessed by software, and be used to generate reports.

For example, a locked biosignal recorder for recording ECGs may only allow the patient to display the calculated heart rate but not the ECG waveforms. After the biosignal recorder is unlocked, the patient can access the true ECG signal that consists of a P wave, a QRS complex and a T wave that can be used to provide a basis for a diagnosis that would not be available from a simple heart rate on a locked biosignal recorder.

Monitoring server 110 receives biosignal recordings from patient/consumer registered with monitoring server 110 from one of biosignal recorders 130a-c. A patient/consumer can upload their biosignal recording for review by a certified physician, or qualified technician, to provide a report that can include a diagnosis and recommendations. Physicians and technicians can access monitoring server 110 and stored biosignals through another computing device connected to communication network 120 that can be located remotely from monitoring server 110. Monitoring server 110 can also transmit the reports generated by physicians and technicians to the patient/consumers, such as by transmitting reports to the computing device (e.g. mobile device 132, personal computer 134 or integral computing device for biosignal recorder 130b) associated with the patient/consumer's biosignal recorder 130a-c.

Monitoring server 110 can also control the state of biosignal recorders 130a-c to allow biosignal recorders 130a-c to transition from an initial locked state (e.g. the state that biosignal recorders 130a-c are purchased as an OTC device) to an unlocked state where the patient/consumer can obtain immediate access to recorded biosignals from a biosignal recorder 130a-c.

Monitoring server 110 can be operated by a hospital, clinic or independent diagnostic testing facility or laboratory. Preferably, monitoring server 110 is operated as a central biosignal recording service that provides monitoring and reporting services to patients/consumers. Monitoring server 110 can be implemented as a pay service for obtaining review and reports on recorded biosignals from biosignal recorders 130a-c.

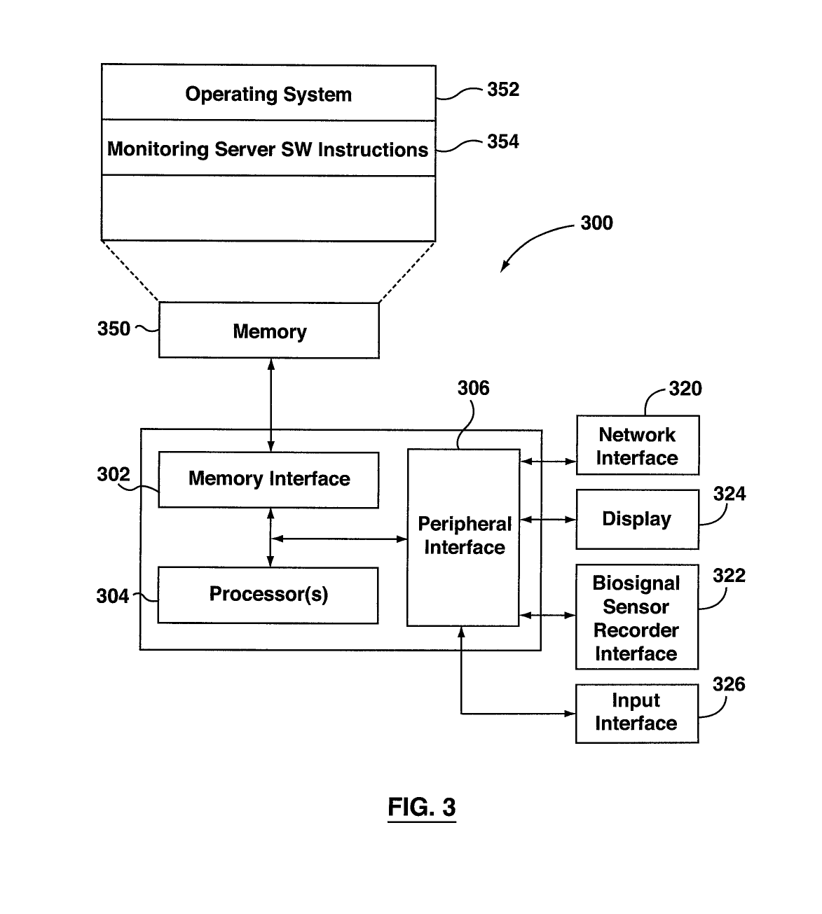

Monitoring server 110 can be implemented as one or more physical computers, each having a processor, memory and a network interface. In some embodiments, various elements of monitoring server 110 can be distributed among multiple servers in order to provide geographical or logical separation, or to provide redundancy and backup services. An exemplary hardware architecture of monitoring server 110 is further described with respect to FIG. 3.

Monitoring server 110 is illustrated in FIG. 1 having an access portal 112, registry 114, biosignal recording storage 116, and report storage 118. Each of these elements can be implemented in software executing on monitoring server 110. Further software elements may be included in monitoring server 110 as are known to a person skilled in the art. In some embodiments, monitoring server 110 can further include a billing element that can charge a fee to patient/consumer to have a biosignal analyzed.

Access portal 112 can provide an access point to monitoring server 110 for access by patients/consumers, professionals and computing devices coupled to biosignal recorders 130a-c. Access portal 112 can be a web interface on monitoring server 110 to allow access over the worldwide web using a web browser on a computing device or that can be directly accessed by software executing on the computing device. For example, a patient/consumer can have GEMS Home software from CardioComm Solutions installed on their personal computer 134 that interacts through access portal 112 with monitoring server 110. Access portal 112 can allow patients/consumers to login to monitoring server 110 after the patient/consumer and corresponding biosignal recorder 130a-c is registered with monitoring server 110.

Patients/Consumers can use access portal 112 to upload biosignal recordings and review any reports or recommendations associated with a patient's/consumer's biosignal recording. Physicians and technicians can use access portal 112 to obtain access to biosignal recordings in order to review the recordings and produce reports based on the recordings. The reports can provide a clinical diagnosis based on the biosignal recording.

Registry 114 can store login credentials and other information related to patients/consumer, professionals and biosignal recorders 130a-c. Registry 114 can be implemented as a database that is stored in memory of monitoring server 110 that contains records for patients/consumers, professionals and biosignal recorders 130a-c. Each patient/consumer, professional and biosignal recorder can have a corresponding unique user identifier in registry 114 that can be used to uniquely identify records associated with a patient/consumer, professional or biosignal recorder 130a-c. Patient/Consumer records can include, for example, a name, contact information, subscribed services, and notes related to the patient's medical condition. Biosignal recorder records can include a serial number of the device, a hardware version, a firmware version, and the lock status of the device (e.g. locked, unlock eligible or unlocked). Professional records can identify a physician or technician by name and any associated registration number and set out their permission to access data stored by monitoring server.

The unique user identifiers of registry 114 can also be used to associate patients/consumers with professionals and biosignal recorder. For example, a biosignal recorder having serial number 1234567 can be registered with user “John Smith”. Patients/consumers can also be associated with a particular instance of a software program executing on the computing device associated with one of biosignal recorders 130a-c. Patients/Consumers can also be associated with a physician after a physician has reviewed a biosignal recording from a patient/consumer. When monitoring server 110 receives a confirmation from the patient/consumer that the patient/consumer has reviewed a report produced by a physician the registry 114 can update a professional association to establish a relationship between the professional and patient/consumer.

Registry 114 can store the lock status of biosignal recorders 130a-c with respect to allowing patient/consumer access to biosignal recordings. Biosignal recorders 130a-c can have different capabilities depending on if the device is locked, unlocked or unlock eligible. After a patient-professional relationship has been established, registry 114 can be updated for a device record to indicate the biosignal recorder is eligible for unlocking to allow the patient/consumer access to further biosignal recordings from the biosignal recorder. After the patient/consumer has completed the unlocking process, registry 114 can be updated to indicate that the biosignal recorder is unlocked.

Preferably, the lock status is associated with a biosignal recorder and patient/consumer pair to control operation of a particular biosignal recorder with a particular patient/consumer. For example, access to biosignal recordings can be allowed for patient/consumer “John Smith” using the biosignal recorder with serial number 1234567, but access would remain locked for other patients/consumers using the same biosignal recorder or the same patient/consumer using a different biosignal recorder. In other embodiments the lock status can be associated with a software instance executing on the computing device that is associated with the biosignal recorder.

Biosignal recording storage 116 can store biosignal recordings received from biosignal recorders 130a-c (or its associated computing devices). Biosignal recordings are uploaded to biosignal recording storage 116 and can be associated with a particular patient/consumer record and biosignal recorder record in registry 114. A professional, such as a physician, can then access biosignal recordings stored in biosignal recording storage 116 to generate reports and treatment recommendations. Reports generated by professionals can then be stored in report storage 118. Biosignal recording storage 116 and report storage 118 can be implemented using computer data storage of monitoring server 110. Reports and biosignal recordings can also be stored on the computing device associated with biosignal recorder.

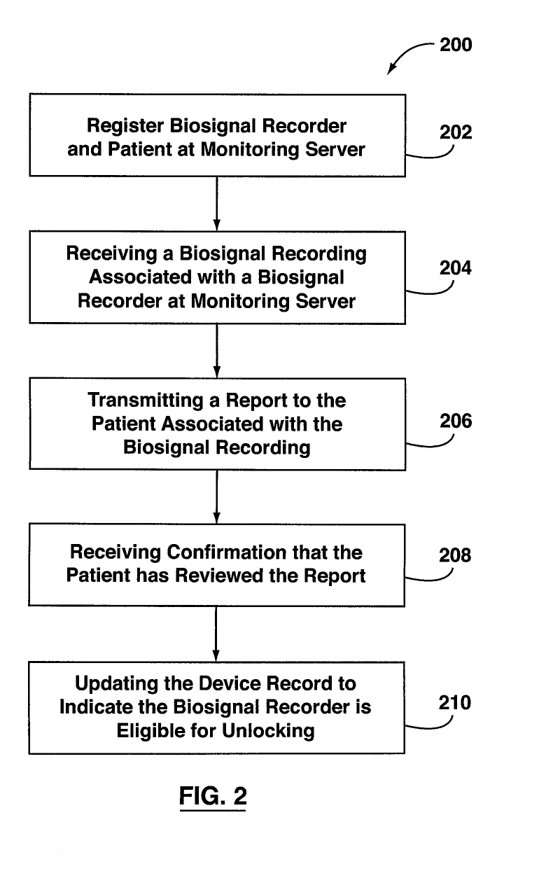

Referring now to FIG. 2, shown is a flow chart diagram illustrating a method 200 for allowing a patient/consumer immediate access to a recorded biosignals on an OTC consumer biosignal recorder. First, at step 202, the patient/consumer and the associated biosignal recorder are registered at monitoring server 110. A patient/consumer can submit a registration request that includes an associated device identifier of the biosignal recorder and a user identifier of the patient/consumer. The patient/consumer can access monitoring server 110 and submit the request through access portal 112 using software on an associated computing device in order to register with the monitoring server 110. Registry 114 can create records for the patient/consumer and biosignal recorder that have a user identifier for the patient/consumer and a device identifier for the biosignal recorder. Registry 114 can associate the patient/consumer with the biosignal recorder by associating the user identifier with the device identifier of the biosignal recorder.

After a patient/consumer has registered with monitoring server 110, next step 204, monitoring server 110 can receive a biosignal recording associated with a device identifier of a biosignal recorder 130a-c. The biosignal recording can be stored in biosignal recording storage 116 at monitoring server 110. The received biosignal recording can include further information to identify either a patient/consumer, a biosignal recording device or both. A professional can then access monitoring server 110 via access portal 112 to review the stored biosignal recording in order to generate a report based on the received biosignal recording.

At step 206, monitoring server 110 transmits the report generated by the professional to the patient/consumer. The patient/consumer can access monitoring server 110 through their biosignal recorder or associated computing device in order to retrieve the report. The patient's/consumer's review of the report generated by a physician creates an equivalent of a doctor-patient relationship. The biosignal recorder or associated computing device can monitor whether the patient/consumer has reviewed the report and transmit this information to the monitoring server 110 when connected via access portal 112.

In step 208, monitoring server 110 receives a confirmation from the patient/consumer confirming that the patient/consumer has reviewed the report. The confirmation can be recorded in registry 114. Next, at step 210, the device record identified by the device identifier associated with the biosignal recorder is updated to indicate that the biosignal recorder is eligible for unlocking to allow the patient/consumer access to further biosignal recordings from the biosignal recorder.

After the device record is updated to indicate that the biosignal recorder is eligible for unlocking, monitoring server 110 can then send an unlock instruction to the biosignal recorder. The unlock instruction can be transmitted in response to receiving a request from a patient/consumer or the biosignal recorder to unlock the biosignal recorder. In some embodiments the unlock instruction can comprise a firmware update that is sent to the biosignal recorder that allows access (e.g. display of recorded signals on display 138 or an associated computing device (e.g. mobile device 132 or personal computer 134).

Referring now to FIG. 3, shown is a block diagram of an exemplary computer architecture 300 of a computing device, such as monitoring server 110 and computing devices associated with biosignal recorders 130a-c illustrated in FIG. 1. A computing device can include memory interface 302, one or more data processors, image processors and/or central processing units 304, and peripherals interface 306. Memory interface 302, one or more processors 304 and/or peripherals interface 306 can be separate components or can be integrated in one or more integrated circuits.

Network interface 320 can be coupled to the peripheral interface 306 to allow communication over communication network 120. In monitoring server 110 the network interface 320 is typically a wired Ethernet connection to a local area network that is part of communication network 120. Computing devices associated with biosignal recorders 130a-c can implement network interface 320 using radio frequency receivers and transmitters and/or optical (e.g., infrared) receivers and transmitters. The specific design and implementation of the network interface 320 can depend on the communication network(s) over which the computing device is intended to operate. For example, mobile device 132 can include network interface 320 designed to operate over a GSM network, a GPRS network, an EDGE network, a Wi-Fi or WiMax network, or a Bluetooth™ network.

Computing devices coupled to biosignal recorders 130a-c can further include a display 324 coupled to peripheral interface 306 that can be used to view biosignal recordings and provide a user interface. Biosignal recorder interface 322 allows a biosignal recorder to coupled to the computing device and can include any number of known interfaces for coupling a peripheral device. An input interface 326 can also be coupled to peripheral interface 306 to allow a user to interact with the computing device. Input interface 326 can allow use of a mouse, keyboard, touchscreen or other known computing device input interfaces.

Memory interface 302 can be coupled to memory 350. Memory 350 can include high-speed random access memory and/or non-volatile memory, such as one or more magnetic disk storage devices, one or more optical storage devices, and/or flash memory (e.g., NAND, NOR). Memory 350 can store operating system 352, such as Darwin, RTXC, LINUX, UNIX, OS X, WINDOWS, or an embedded operating system such as VxWorks. Operating system 352 may include instructions for handling basic system services and for performing hardware dependent tasks. In some implementations, operating system 352 can comprise a kernel (e.g., UNIX kernel).

In the case of monitoring server 110, memory 350 can also store software instructions 354 for implementing method 200 and providing the functionality of monitoring server elements (e.g. access portal 112, registry 114, biosignal recording storage 116, and report storage 118). Monitoring server software instructions 354 are executed by processor 304 to configure monitoring server 110 to provide the functions described herein.

Software instructions 354 can correspond to a set of instructions for performing one or more functions described above. Software instructions 354 need not be implemented as separate software programs, procedures, or modules. Furthermore, various functions of computing device 400 can be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for allowing a patient/consumer immediate access to recorded biosignals on an over-the-counter consumer biosignal recorder, the method comprising:
receiving at a server a registration request having an associated device identifier of the biosignal recorder and a user identifier of the patient/consumer;
associating the user identifier with a device record stored in memory at the server, the device record identified by the device identifier;
receiving at the server and storing in the memory a biosignal recording associated with the device identifier;
transmitting a report from the server to the patient/consumer, the report prepared by a professional after review of the biosignal recording;
receiving a confirmation from the patient/consumer at the server confirming that the patient/consumer has reviewed the report, the confirmation establishing a relationship between the professional and patient/consumer; and
after receiving the confirmation, updating the device record identified by the device identifier of the biosignal recorder to indicate the biosignal recorder is eligible for unlocking to allow the patient/consumer access to further biosignal recordings from the biosignal recorder.

2. The method of claim 1 further comprising:
after updating the device record to eligible for unlocking, transmitting an unlock instruction to the biosignal recorder.

3. The method of claim 2, wherein transmitting the unlock instruction is performed in response receiving an unlock request from the patient/consumer.

4. The method of claim 2, wherein the unlock instruction comprises a firmware update to allow access to recorded biosignals on the biosignal recorder.

5. The method of claim 1, wherein the biosignal is an electrocardiogram.

6. The method of claim 1, wherein the biosignal is any one of an electroencephalogram (EEG), magnetoencephalogram (MEG), galvanic skin response (GSR), electrocardiogram (ECG), electromyogram (EMG), and heart rate variability (HRV).

7. The method of claim 1, wherein the report provides a clinical diagnosis based on the biosignal recording.

8. The method of claim 1, wherein the biosignal recorder comprises a biosignal display.

9. The method of claim 8, wherein the biosignal display is provided by a personal computer coupled to the biosignal recorder.

10. The method of claim 8, wherein the biosignal display is provided by a mobile device coupled to the biosignal recorder.

11. A monitoring server for allowing a patient/consumer immediate access to recorded biosignals on an over-the-counter consumer biosignal recorder, the system comprising:
a memory for storing software instructions; and
a processor for executing the software instructions to configure the processor to:
receive at the monitoring server a registration request having an associated device identifier of the biosignal recorder and a user identifier of the patient/consumer;
associate the user identifier with a device record stored in the memory, the device record identified by the device identifier;
receive at the server and store in the memory a biosignal recording associated with the device identifier;
transmit a report from the server to the patient/consumer, the report prepared by a professional after review of the biosignal recording;
receive a confirmation from the patient/consumer at the server confirming that the patient/consumer has reviewed the report, the confirmation establishing a relationship between the professional and patient/consumer; and
update the device record identified by the device identifier of the biosignal recorder after receiving the confirmation to indicate the biosignal recorder is eligible for unlocking to allow the patient/consumer access to further biosignal recordings from the biosignal recorder.

12. The monitoring server of claim 11, wherein the processor is further configured to:
transmit an unlock instruction to the biosignal recorder after updating the device record to eligible for unlocking.
